(19) United States
(12) Patent Application Publication
(10) Pub. No.: US 2021/0203160 A1
(43) Pub. Date: Jul. 1, 2021

(54) METHOD FOR THE AUTOMATIC MANAGEMENT METHOD OF A FLOW OF ELECTRICAL ENERGY

(71) Applicant: Commissariat à I'énergie atomique et aux énergies alternatives, PARIS (FR)

(72) Inventors: Duy Long HA, GRENOBLE CEDEX 9 (FR); Moch-Arief ALBACHRONY, GRENOBLE CEDEX 9 (FR); Yves-Marie BOURIEN, GRENOBLE CEDEX 9 (FR); Quoc-Tuan TRAN, GRENOBLE CEDEX 9 (FR)

(21) Appl. No.: 17/131,096

(22) Filed: Dec. 22, 2020

(30) Foreign Application Priority Data
Dec. 30, 2019 (FR) 1915737

(51) Int. Cl. H02J 3/00; H02J 3/38; H02J 3/32; G05B 19/042

(52) U.S. Cl. CPC H02J 3/004; H02J 3/003; H02J 3/381; G05B 2219/2639; G05B 19/042; H02J 2300/24; H02J 2310/12; H02J 3/32

(57) ABSTRACT

A method for automatically managing a flow of electrical energy produced by a first group of prosumers and consumed by the first group of prosumers and a second group of consumers, wherein each entity determines, at the beginning of a predetermined period, a production forecast and/or a consumption forecast of electrical energy, the method including determining, for each group, an order for consulting the entities of the group, consulting all the prosumers according to the order determined previously, each prosumer calculating a residual production forecast taking account of its own production forecasts, a residual production forecast transmitted by a preceding entity and a portion of a consumption forecast that can be supplied by the residual production forecast, and transmitting this residual production forecast to the prosumer according to the determined order, when the production forecasts are in surplus, transmitting the residual production forecasts to the group of consumers.

### TECHNICAL FIELD OF THE INVENTION

The present invention relates to a method for automatically managing a flow of electrical energy that makes it possible to equitably and optimally distribute the electrical energy between prosumers of this energy and consumers.

The invention has applications in the fields of the production and distribution of electrical energy. It has, in particular, applications in the field of the production of electrical energy by private stand-alone electricity production devices.

### TECHNOLOGICAL BACKGROUND OF THE INVENTION

In the field of the distribution of electricity, it is known that the general electricity distribution network—more simply called the general distribution network—supplies with electricity each housing, industry, commercial premises, and any other consumer of electricity, and invoices each one of these entities according to their own consumption, namely the number of kWh (kilowatt-hours) consumed. For several years now, stand-alone electricity production devices, which produce a renewable energy, have appeared. These stand-alone electricity production devices, such as for example the photovoltaic, wind turbine or hydraulic devices, are installed on buildings or private land to supply, at least cost, said buildings with electricity. The installations that comprise a stand-alone electricity production device allow for self-consumption, i.e. the local consumption of the electricity produced locally.

However, these stand-alone electricity production devices do not produce a quantity of energy that is evenly distributed over a day. For example, photovoltaic panels produce electrical energy only during the day, after sunrise. Thus, a building on which photovoltaic panels are installed will be supplied with electrical energy only between sunrise and sunset. At night, as the quantity of electrical energy produced is zero or very low, the building is supplied with electricity by the general electricity distribution network. On the contrary, during the day, it is frequent that the quantity of electrical energy produced by these photovoltaic panels is higher than the quantity of electrical energy consumed by the building. The surplus electrical energy, i.e. the electrical energy produced by the stand-alone electricity production device and not consumed by the building, is generally resold at low cost to the general distribution network, with the cost of the kWh purchased by the general distribution network being in general lower than the cost of the kWh sold by said general distribution network. Another possibility is to store the non-consumed electrical energy, in a suitable storage device such as, for example, a solar battery in the case of electrical energy produced by solar panels. However, not only is this arrangement of storing electrical energy not allowed in all countries, but in addition it has a non-negligible cost.

The profitability of a stand-alone electricity production device is therefore generally improved by the capacity to maximise the self-consumption of the electricity produced, and therefore the self-consumption rate of said device. This self-consumption rate is defined as the percentage of the production of electrical energy consumed on site. More precisely, the self-consumption rate, noted as Self-Consump Rate, is defined by the formula:

$$Self \text{-} Consump Rate = \frac{ENR self \text{-} consumed}{ENR produced} * 100 ,$$

where ENR self-consumed is the quantity of electrical energy consumed on site and ENR produced is the quantity of electrical energy produced by the stand-alone electricity production device.

In most installations, the self-consumption rate is close to 20% to 30%. In order to increase this self-consumption rate, and as such improve the profitability of stand-alone electricity production devices, private installations that produce and consume electricity—called here prosumers—can be connected to entities that only consume (named consumers or consumer entities) so that the electrical energy produced by the prosumers is consumed not only by the prosumers but also by the consumers. The model according to which prosumers are grouped together with consumers so as to distribute the electrical production is called collective self-consumption model or virtual self-consumption model. This collective self-consumption model allows private individuals, collectivities, companies, condominiums, etc., that are geographically close to each other (i.e. of which the withdrawal and injection points with the general distribution network are located downstream of the same medium to low voltage electricity transformation substation) to group themselves together within a legal entity in order to share the production of electricity.

However, although a collective self-consumption model has the advantage of increasing the self-consumption rate, it also has the disadvantage of requiring appropriate management of the distribution of the flow of electrical energy produced by the prosumers (or productive entities). It also requires appropriate management of the flow of electrical energy purchased from the general distribution network, when the flow of electrical energy produced is insufficient. In other words, the flow of electrical energy produced must be shared equitably between all the entities of the collective self-consumption model in order for this model to be interesting financially for all the entities (productive entities and consumer entities).

The document of Plaza Caroline, Julien Gil, Francois de Chezelles, and Karl Axel Strang entitled “Distributed Solar Self-Consumption and Blockchain Solar Energy Exchanges on the Public Grid Within an Energy Community” and published in 2018 in IEEE International Conference on Environment and Electrical Engineering and IEEE Industrial and Commercial Power Systems Europe (EEEIC/I&CPS Europe), proposes a solution for sharing electrical energy produced. This solution consists of a method for counting that makes it possible to account for the quantity of energy by using the so-called “blockchain” technology for the encryption within the community of entities. However, the method proposed in this document only makes it possible to manage the exchanges of electrical energy according to rules preestablished by the community. It does not allow for an equitable management of the flow of energy according to the needs of each entity and of the quantity of electrical energy produced.

The document of Verschae Rodrigo, Takekazu Kato, Hiroaki Kawashima and Takashi Matsuyama, entitled “A Cooperative Distributed Protocol for Coordinated Energy Management in Prosumer Communities” and published in December 2015 in Technical Report of IEICE, proposes method for negotiation between prosumers. However, this method comprises two levels that are rather complex to implement and requires substantial computational power. Furthermore, this method does not take account of the exact contribution of each entity and in particular the consumption of consumers and the production of prosumers.

There is therefore a genuine need for a technology that makes it possible to equitably manage the flow of electrical energy produced, between the prosumers and the consumers, taking account of the contribution of each one of the entities.

### SUMMARY OF THE INVENTION

To respond to the problems mentioned hereinabove of not taking the needs of the different entities into account, the lack of equity in the distribution of the electrical energy produced and of the need for a simple solution from a calculating standpoint, the applicant proposes a method for managing the flow of electrical energy according to the forecast needs and the actual needs of each entity, whether it produces or consumes electricity.

According to a first aspect, the invention relates to a method for automatically managing a flow of electrical energy produced by at least one first group of prosumers and consumed by said first group of prosumers and at least one second group of consumers, wherein each entity of each group determines, at the beginning of a predetermined period, a production forecast and/or a consumption forecast of electrical energy for the predetermined period, the method comprising the following operations:
a) determining, for each group, an order for consulting the entities of the group,
b) consulting the prosumers according to the order determined in step a), each prosumer calculating a residual production forecast taking account of its own production forecasts, a residual production forecast transmitted by a preceding entity and a portion of a consumption forecast that can be supplied by the residual production forecast, and transmitting this residual production forecast to the prosumer according to the determined order,
c) reiterating step b) as long as all the prosumers have not been consulted,
d) when the residual production forecasts are in surplus, transmitting said residual production forecasts to the group of consumers,
e) consulting the consumers according to the order determined in step a), each consumer calculating and transmitting, to the consumer according to the determined order, the residual production forecast taking account of the residual production forecast transmitted by the preceding entity and of its portion of consumption forecast that can be supplied,
f) reiterating step e) as long as all the consumers have not been consulted,
g) reiterating steps b) to f) as long as a predetermined convergence criterion has not been reached.

This method makes it possible to improve the self-consumption rate of all the entities connected in a network and to distribute, with a regular change in the orders for consulting, the electrical energy produced between the different entities equitably, taking account of the contribution of each one of the entities.

In the rest of the description, reference shall be made indifferently to “electrical energy” or “electricity”, a quantity of electricity produced or consumed, accounted for in kWh (kilowatt-hour).

Advantageously, step b) comprises the following operations:
calculating an aggregate production forecast that corresponds to its production forecasts added to any residual production forecast transmitted by a preceding entity,
identifying a portion of its consumption forecast that can be supplied by this aggregate production forecast,
calculating a residual production forecast that corresponds to the aggregate production forecast less the portion of its consumption forecast that can be supplied,
calculating a residual consumption forecast that corresponds to its consumption forecast less the portion of its consumption forecast that can be supplied, added to any residual consumption forecast transmitted by a preceding entity, and
transmitting to the prosumer according to the determined order, the calculated residual production forecasts and consumption forecasts;
   and the step e) comprises the following operations:
identifying a portion of its consumption forecast that can be supplied by the residual production forecast transmitted by the preceding entity,
calculating the residual production forecast that corresponds to the residual production forecast transmitted by the preceding entity less the portion of its consumption forecast that can be supplied,
calculating the residual consumption forecast that corresponds to its consumption forecast less the portion of its consumption forecast that can be supplied, added to any residual consumption forecast transmitted by a preceding entity, and
transmitting to the consumer according to the determined order, the calculated residual production forecasts and consumption forecasts.

The first and the second groups of entities being connected to a general electricity distribution network, the method comprises, advantageously, at the end of at least one predetermined period, the establishing of an energy assessment based on a comparison, for each entity of each group, between the production forecasts and the actual production and/or between the consumption forecasts and the actual consumption of the entity.

Advantageously, the establishing of the energy assessment comprises the following operations:
I) consulting each prosumer according to the order for consulting determined in step a) each prosumer:
   calculating the aggregate actual production that corresponds to its actual production added to any actual residual production transmitted by the preceding entity,
   identifying a portion of its actual consumption that can be supplied by this aggregate actual production,
   calculating the actual residual production that corresponds to the aggregate actual production less the maximum portion of its actual consumption that can be supplied,
   calculating the residual actual consumption that corresponds to its actual consumption less the portion of its actual consumption that can be supplied, added to any residual actual consumption transmitted by the preceding entity,
   transmitting said actual residual production and said actual residual consumption to the next prosumer according to the order for consulting,
m) reiterating step b) as long as all the prosumers have not been consulted,
n) consulting the consumers according to the order for consulting determined in step a), each consumer determining the actual residual consumption of said consumer and the actual residual production, and transmitting said actual residual consumption and the actual residual production to the next consumer according to the order for consulting,
o) reiterating step n) as long as all the consumers have not been consulted, and
p) establishing the energy assessment that indicates, for each one of the prosumers and consumers, the quantity of electrical energy consumed supplied by the prosumers and the quantity of electrical energy consumed supplied by the electricity distribution network.

In addition to the characteristics that have just been mentioned in the preceding paragraph, the method for managing according to an aspect of the invention can have one or more additional characteristics among the following, taken individually or in any technically permissible combination:
the order for consulting the entities determined in step a) is modified at the beginning of each predetermined period.
the order for consulting is chosen randomly.
the consumption forecasts are optimised by each one of the prosumers and consumers according to the production forecasts and/or residual production forecasts transmitted by the preceding entity.
the consumption forecasts are optimised by each one of the prosumers and consumers by choosing, over time, the most appropriate moment of consumption according to the production forecasts and/or residual production forecasts transmitted by the preceding entity.
when the residual production forecasts are higher than the residual consumption forecasts of the groups of prosumers and consumers, the electrical energy actually produced is stored in a storage device in order to be consumed thereafter.
several pools, each comprising at least one first group of prosumers and at least one second group of consumers, are connected to share the flow of electrical energy produced by the first groups of prosumers by applying, pool by pool, the steps a) to g) and l) to p) when the residual production forecasts of one of the pools are higher than the consumption forecasts of said pool.
the method comprises an operation of establishing a global assessment that indicates, for each one of the pools, the quantity of electrical energy consumed supplied by the pools and the quantity of electrical energy consumed supplied by the electricity distribution network.
the pools are consulted according to an order for consulting modified at the beginning of each predefined period.
when a first pool and a second pool comprise the same prosumer or consumer, said entity is consulted before the second pool.

According to a second aspect, the invention relates to a unit for processing a flow of electrical energy produced by at least one first group of prosumers and consumed by said first group of prosumers and at least one second group of consumers, characterised in that it provides at least the determining of the order for consulting the entities, the management of the consultation of said entities and the verification of the predetermined convergence criterion.

According to a third aspect, the invention relates to a network of electricity self-consumption entities, characterised in that it comprises:
a plurality of prosumers and consumers connected locally to one another, and
at least one unit for processing a flow of electrical energy such as defined hereinabove and connected to each one of the consumers and prosumers.

Advantageously, the network of self-consumption entities is connected to the general electricity distribution network.

According to a fourth aspect, the invention relates to a computer program, characterised in that it comprises instructions that, when they are executed by a unit for processing a flow of electrical energy, are able to implement the method such as defined hereinabove to automatically manage the flow of electrical energy produced by at least one first group of prosumers and consumed by said first group of prosumers and at least one second group of consumers.

### BRIEF DESCRIPTION OF THE FIGURES

Other advantages and characteristics of the invention shall appear when reading the following description, shown in the figures wherein:

FIG. 1 diagrammatically shows an example of a network of self-consumption entities according to the invention;

FIG. 2 diagrammatically shows an example of several entities connected in a network of self-consumption entities according to the invention;

FIG. 3 diagrammatically shows an example of two networks of self-consumption entities connected together;

FIG. 4 diagrammatically shows an example of the transmission of the forecast values of the production and consumption of electricity between two networks of self-consumption entities;

FIG. 5 shows an example of a flowchart for determining the forecast distribution of the flow of electrical energy within a network of self-consumption entities;

FIG. 6 shows an example of a flowchart for establishing the energy assessment within a network of self-consumption entities;

FIG. 7 shows, in the form of a stacked bar graph, a chronological example of non-optimised and optimised production forecasts and consumption forecasts;

FIG. 8 shows, in the form of a table, a comparison of the results of electrical consumption obtained with a method according to the prior art and the method according to the invention.

### DETAILED DESCRIPTION

An embodiment of a method for automatically managing a flow of electrical energy produced by a stand-alone electricity production device allowing for an equitable distribution of the electricity produced is described in detail hereinafter, in reference to the accompanying drawings. This example shows the characteristics and advantages of the invention. It is however reminded that the invention is not limited to this example.

In the figures, identical elements are marked with identical references. For reasons of legibility of the figures, the size scales between the elements shown are not respected.

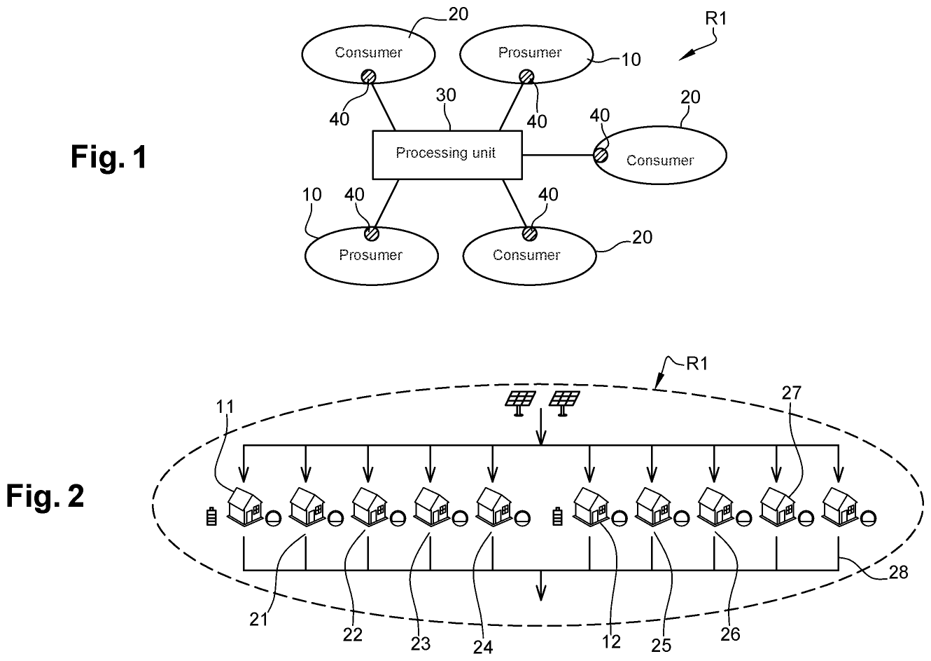

The method for automatically managing a flow of electrical energy according to the invention has for purpose to equitably manage and through a facilitated calculation the quantity of electricity produced by one or more prosumers and consumed by said prosumers as well as by consumers, the prosumers and the consumers being connected to one another in order to form a network of self-consumption entities—also called a pool—of which an example is shown in FIG. 1.

The term “prosumer” means any building (such as: housing, commercial premises, industry, private land, etc.) equipped with one or more stand-alone electricity production devices (or autonomous electricity production devices) that allows said building a local production of electricity that can make it possible to supply a portion of its consumption (notion of self-consumption of the electricity in the premises of the building). The term “consumer” means any building (such as: housing, commercial premises, industry, etc.) equipped with devices that consume electricity (such as: washing machine, television, computer, radiator, etc.).

As shown in FIG. 1, the network of self-consumption entities R1 comprises several prosumers 10 and several consumers 20, all connected to a processing unit 30 that provides the implementation, within the network of self-consumption entities, of the method which shall be described in what follows. Each prosumer 10 and each consumer 20 comprises a connection interface 40 allowing for data exchange, via a wired or wireless connection, between the processing unit 30 and said entity. The processing unit 30 can be a computer, a box or any other calculator, located in one of the entities or in independent premises and implementing a computer program that can execute instructions that correspond to the operations that shall be described in what follows. Alternatively, the processing unit 30 can also be “virtual” and stored in the form of a computer program on a relocated infrastructure, i.e. located at a distance (of several kilometres) from the self-consumption entities, and communicating with the connection interfaces of said entities via a telecommunication network such as the Internet network.

An example of a network of self-consumption entities is shown in FIG. 2. This network of self-consumption entities R1 comprises ten entities connected to each other, for example ten houses of the same neighbourhood, with eight consumers 21-28 and two prosumers 11 and 12, producing electrical energy by means of photovoltaic panels.

According to certain embodiments, the network of self-consumption entities is connected to a general electricity distribution network (not shown in figure) that makes it possible to supplement the supply of electricity, when the prosumers of the network of self-consumption entities do not provide enough electricity to ensure the electricity needs of the entire said network of self-consumption entities.

The processing unit 30 implements a method intended to establish, for a predetermined period, the production forecasts by all the prosumers 10—also called first group of entities—and the consumption forecasts by the consumers 20—also called the second group of entities—as well as by the prosumers. This predetermined period is of a duration that is sufficiently short to allow each prosumer or consumer to assess its consumption forecasts and is sufficiently long to allow each prosumer to assess its electricity production forecasts. This predetermined period can be, for example, a period of a few hours, a day, or a few days.

The electricity production forecasts and consumption forecasts for a network of self-consumption entities are carried out iteratively until a convergence criterion is reached. The successive iterations are carried out firstly for the prosumers so as to determine the global quantity of electrical energy produced on a forecast basis by the network of self-consumption entities, during the predetermined period. The successive iterations are then carried out for the consumers so as to determine the quantity of electrical energy on a forecast basis required to supply the network of self-consumption entities during the predetermined period.

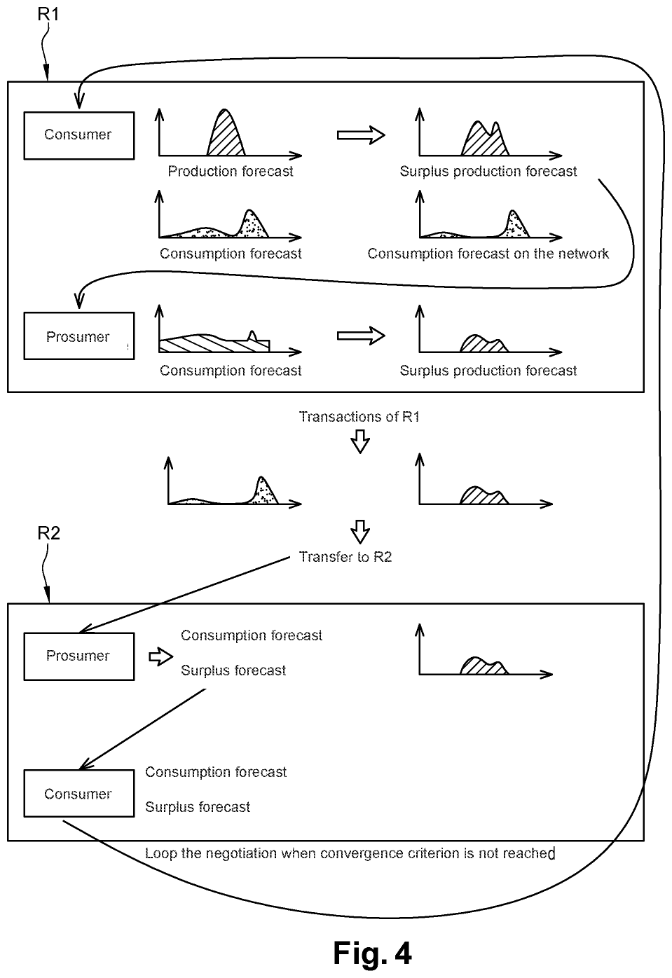

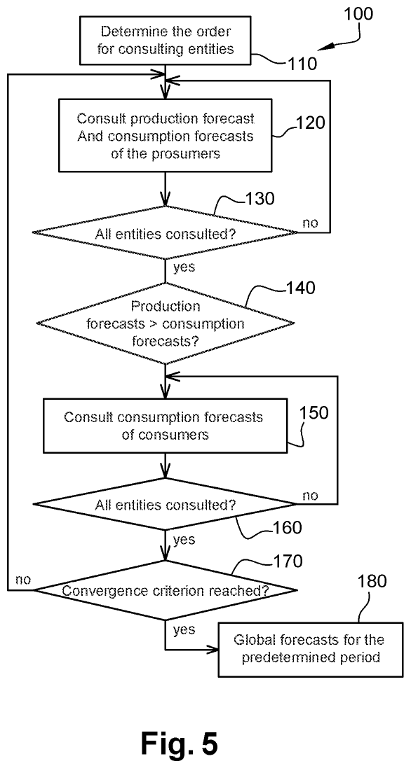

More precisely, and as shown in FIGS. 4 and 5, the method 100 for establishing the production and consumption forecasts comprises a first step 110 consisting of choosing an iteration order of the entities. This iteration order, also called order of consulting, is the order wherein the entities are consulted to supply their forecasts and the order wherein the residual productions and consumptions are aggregated. It is modified at each new predetermined period in order to ensure equity in the network of self-consumption entities. This iteration order can be, for example, random; the prosumers, and respectively the consumers, are then consulted arbitrarily, one after the other. Alternatively, the iteration order can be a predetermined order or a predefined rotation, alternated at each new period. Regardless of the choice of the iteration order, this order is modified at each predefined period—for example at each beginning of the day if the predefined period is a day—or at each set of several predefined periods,—for example every two or three days—so that the hierarchy according to which the entities are consulted is regularly (and often) modified.

The method 100 is repeated at the beginning of each predetermined period, for example at the beginning of each day. The method 100 comprises, after the choice 110 of the iteration order, a step 120 of consulting prosumers who supply, each in turn, their residual production forecasts and their residual consumption forecasts for the period. The residual production forecasts correspond to the production forecasts of the entity, aggregated with the residual production forecast transmitted by the preceding entity when it is present, and from which are subtracted the consumptions of the entity that can be supplied by the own production of said entity as well as by the non-used residual production of the preceding entities in the chain of consultation. The residual consumption forecast corresponds to the consumption forecast, once deducted the production that can be allocated to it, aggregated with the residual consumption forecast transmitted by the preceding entity when it is present. The consumption forecast of the entity that can be supplied by its own production and the non-used residual production of the preceding entities in the chain of consultation is called “portion of the consumption forecast that can be supplied”. In the rest of the description, it is understood that for each entity, this calculation of residual productions and consumptions will be carried out before any diffusion of the characteristics of residual production and of residual consumption to the following entities in the process of consultation. At the end of each consultation, the prosumer 10 transmits its residual production and residual consumption forecasts to the following prosumer according to the chosen iteration order. These residual production and residual consumption forecasts can be transmitted directly from one entity to another entity; they can, alternatively, be transmitted from one entity to another through the processing unit, with each entity then exchanging only with the processing unit 30 (example of FIG. 1). Regardless of the method of transmission, the residual production forecasts and the residual consumption forecasts are transmitted iteratively from a prosumer to the following prosumer. Each prosumer adds the residual production and consumption forecasts received to its own production and consumption forecasts, and carries out a new calculation of the residual production forecast and of the residual consumption forecast by internally seeking to use the production available (i.e. local production and residual production transmitted by the preceding entity) in order to best satisfy its local consumption. This production availability at the level of a given entity, aggregating the production of the entity with the production residual transmitted by the preceding entity, is called aggregate production. Thus, the production forecasts and the consumption forecasts are aggregated as the consultations of prosumers takes place while still be valorised when this is possible internally to the entities and, after consultation of all the prosumers, it is possible to assess whether a positive residual production remains or if all the production was self-consumed.

The step 120 which has just been described is reiterated as long as all the prosumers 10 have not been consulted (operation 130). When all the prosumers have been consulted, the method proposes to verify if the production forecasts are in surplus. In other words, the method proposes to verify if the residual production forecasts are positive or zero, i.e. if there is any non-consumed residual production forecast (operation 140). If the residual production forecast is zero (i.e. the production forecast was entirely consumed by the successive entities), then the global forecasts (i.e. all the consumption forecasts and production forecasts) are considered as determined for the predetermined period (step 180). However, if the surplus forecasts are positive, i.e. if there remains any non-zero residual production forecast, the residual production forecast of step 120 and the residual consumption forecast of the step 120 are transmitted to the first consumer (i.e. the first consumer according to the order determined in step 110). The consumers are then consulted (step 150) iteratively, one after the other by following the order established in step 110. During this step 150, and according to the same principle as during step 120, each consumer calculates its residual consumption forecasts for the predetermined period and the residual production forecasts, based on residual consumption and production forecasts received as well as on its own consumption. The step 150 is reiterated as long as all the consumers have not been consulted (test 160).

The steps 120 to 160 are reiterated a plurality of times so as to optimise the consumption forecasts with respect to the production forecasts. At the end of the step 160, the residual productions and consumptions are supplied as input for the first prosumer of the step 120 during an iteration. The forecasts obtained are considered to be optimal when the self-consumption rate reaches 100%, i.e. when the surplus in production forecast is zero. Indeed, the method according to the invention has for objective to obtain zero production surplus. The method therefore seeks, in a first step, to obtain a production forecast in surplus equal to zero. Iteratively consulting the different entities makes it possible to little by little approach this objective. However, it is not always possible to obtain a production forecast in surplus that is equal to zero. In this case, it is considered that if a predefined convergence criterion is reached, then the forecasts obtained are optimal. For this, in the example of the method shown in FIG. 5, the test 170 proposes to verify that the convergence criterion is reached. In other words, when all the prosumers and consumers have been consulted, the method comprises a step 170 consisting of verifying if the convergence criterion is reached. This convergence criterion can be, for example, a value of the production surplus, a convergence speed, a minimum rate of improvement with respect to the preceding iteration, a maximum iteration time of steps 120 to 160, etc. For certain criteria, the convergence can be considered as reached when the net result of production and/or consumption forecasts for an entity is only marginally different from the net result of production and/or consumption forecasts from the preceding calculation iteration.

In the method 100, as long as the convergence criterion is not reached, the steps 120 to 160 are reiterated. When the convergence criterion is reached, it is considered that the global forecasts (i.e. all the consumption forecasts and production forecasts) are determined (step 180).

Steps 120 to 180 described hereinabove are implemented, at the beginning of the predetermined period, for example at the beginning of the day, in order to determine the optimum consumption forecasts for the electrical energy produced during the predetermined period. At the end of this predetermined period, or several aggregated predetermined periods, an energy assessment is established iteratively so as to determine the actual distribution of the flow of energy for the predetermined period or periods. This energy assessment is established by comparing, for each entity, the production forecasts with the actual production and the consumption forecasts with the actual consumption. More precisely, the energy assessment is established by iteratively consulting each one of the prosumers according to the order established in step a) by taking account, on the one hand of actual production, and on the other hand the actual consumption and by carrying out the assessment of the actual residual productions and actual residual consumptions of all the prosumers according to the order established in step a) and by following the same calculation principles as during the forecast calculation step then by similarly continuing the assessment of the actual residual production and consumptions over all the consumers, still according to the same calculation principles as during the forecast calculation step. In the case of consumers, only actual consumption is taken into account, but which influences both the actual residual production, which is propagated entity after entity and may potentially be consumed along the way, and the actual residual consumption which tends to aggregate from entity to entity.

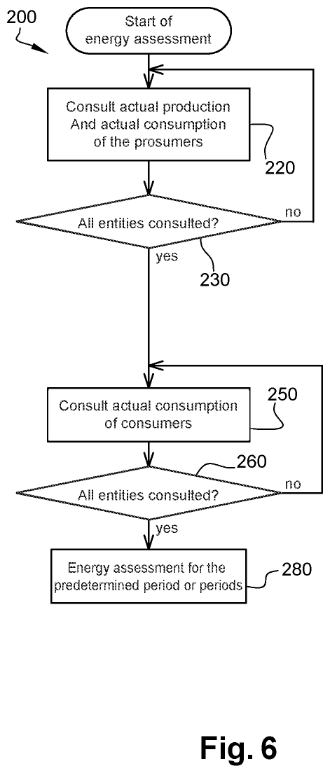

The method 200 for establishing an energy assessment, of which a flowchart example is shown in FIG. 6, is implemented, at each end of a predetermined period or after several predetermined periods—for example at the end of each day or week when the predetermined period is a day. The method 200 comprises a step 220 for consulting prosumers who supply, each in turn, the actual residual production produced by the prosumer during the or all of the predetermined periods and the actual residual consumption for this same period or set of periods. At the end of each consultation, the prosumer transmits its residual production and consumption values to the following prosumer according to the chosen iteration order. The values of the residual production and consumption can be transmitted directly from one entity to another entity; they can, alternatively, be transmitted from one entity to another through the processing unit, with each entity then exchanging only with the processing unit (example of FIG. 1). Regardless of the method of transmission, the values of the residual production and the values of the residual consumption are transmitted iteratively from one prosumer to the following prosumer, with each prosumer adding the residual production values received to its own production values, and confronts its own actual consumption in order to identify the potential for local self-consumption, and calculate the new values of residual actual production and consumption to be transmitted which integrated this self-consumption, in such a way that the actual residual production and consumption values are aggregated as the consultations of the prosumers take place, by integrating their local self-consumptions.

The step 220 that has just been described is reiterated as long as all the prosumers have not been consulted (test 230). When all the prosumers have been consulted, the residual production values resulting from the step 220 and the residual consumption values resulting from the step 220 are transmitted to the first consumer (i.e. the first consumer according to the order determined in step 110). The consumers are then consulted (step 250) iteratively, one after the other by following the order established in step 110.

During this step 250, each consumer calculates, similarly to step 220, the actual residual consumption consumed by the consumer during the or all of the predetermined periods and the actual residual production produced for this same period or set of periods. At the end of each consultation, the consumer transmits the residual production values and the residual consumption values to the following consumer according to the chosen iteration order. The residual production and consumption values can be transmitted directly from one entity to another entity; they can, alternatively, be transmitted from one entity to another through the processing unit, with each entity then exchanging only with the processing unit (example of FIG. 1). Regardless of the method of transmission, the residual production and consumption values are transmitted iteratively from one consumer to the following consumer, each consumer confronting its own actual consumption with the actual residual production transmitted by the preceding entity, in order to identify the potential for local self-consumption, and calculate the new residual production and consumption values to be transmitted, in such a way that the actual residual production and consumption values are aggregated as the consultations of consumers take place, by integrating their local self-consumptions. The step 250 is reiterated as long as all the consumers have not been consulted (test 260).

Following this assessment, the portion of the electrical energy produced by each prosumer is known, i.e. the proportion of electricity produced by each one of the prosumers with respect to the total quantity of electricity produced; the portion of the electrical energy consumed by each one of the prosumers/consumers is also known, i.e. the proportion of electricity consumed by each prosumer/consumer with respect to the total quantity of electrical energy consumed. Taking account of the price of the kWh, generally agreed via a contract between the prosumers and the consumers, it is then possible to invoice, to each consumer or prosumer, the quantity of electrical energy consumed by said consumer or prosumer and produced by one or more of the other prosumers.

The iterative method of distributing, within a network of self-consumption entities, the electrical energy produced by the prosumers of said network of self-consumption entities makes it possible to distribute to the maximum said electrical energy and therefore to limit the quantity of electrical energy supplied by the general electricity distribution network.

According to certain embodiments, the method 100 for determining forecasts comprises an operation that consists, during the steps 120 and 150 for consultation, of optimising the consumption forecasts of the prosumers and of the consumers, for example by taking account of the availability of the production. This optimisation operation consists of maximising the consumption during the peaks in the production of the electrical energy. For example, in a network of self-consumption entities wherein the electricity is produced by photovoltaic panels, if an electrical energy peak is expected between 10 h00 and 16 h00 (for example because the sunshine is optimal), the consumers and/or the prosumers can optimise their consumption by choosing to consume to the maximum during this time slot. A consumer can choose, for example, to run the dishwasher and the washing machine during this time slot instead of the initially considered slot before 10 h00 or after 16 h00. Indeed, although certain electricity-consuming devices operate constantly or at times that cannot be modulated, for example heating or the alarm for premises, the operating times of certain devices can, on the contrary, be chosen in such a way as to optimise the consumption of the electrical energy produced.

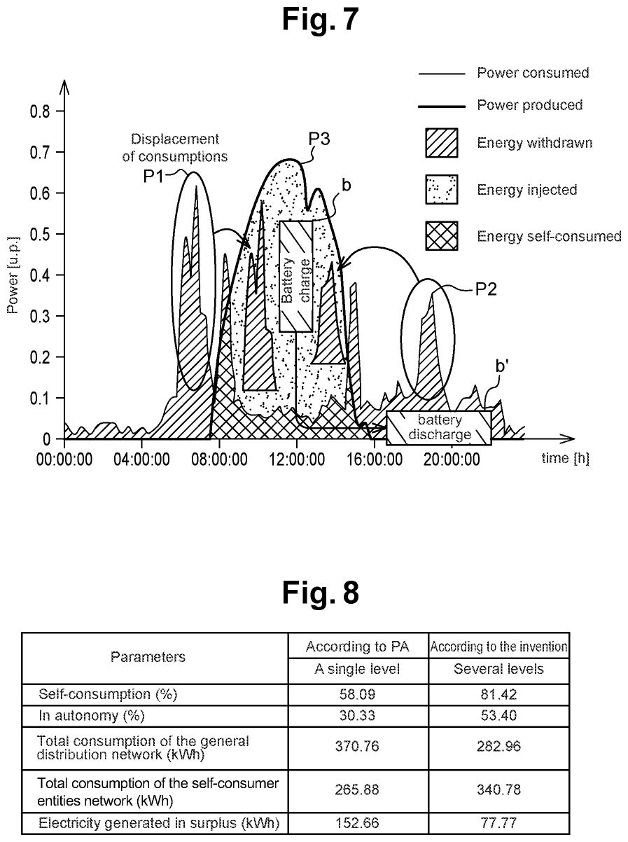

An example of optimisation of the consumption is shown in the diagram of FIG. 7, wherein the hatched zone represents the electrical energy required, over the course of a day, the mottled zone represents the electrical energy generated by the network of self-consumption entities and the squared zone represents the electrical energy self-consumed by the prosumers. In this example, the operation of certain devices that belong to consumers was initially scheduled around 6 h00 and 20 h00. The operation of these devices such as initially scheduled corresponds to consumption peaks p1 and p2 (hatched zone). In the example, the operation of these devices was offset in time, respectively to 10 h00 and 15 h00, so that they consume electricity during the peak p3 of energy production by the network of self-consumption entities. Offsetting the consumption of electrical energy during an electricity production phase makes it possible to optimise the electrical consumption in relation to production and, consequently, to improve the self-consumption rate.

In certain embodiments, it is possible, when the national regulations allow, to store the surplus of electrical energy (i.e. the electrical energy produced but not consumed) is a storage device so that this stored energy can be injected into the network of self-consumption entities at moments when the network of self-consumption entities does not produce or is not producing enough electricity. The diagram of FIG. 7 shows the example of a battery b set to charge during the peak p3 of electricity production and of which the discharge (referenced as b′) is carried out during the peak p2 of consumption. In the example of FIG. 7, injecting electrical energy into the network of self-consumption entities makes it possible to absorb an electrical overconsumption and, consequently, to limit the injection of an electricity coming from the general distribution network.

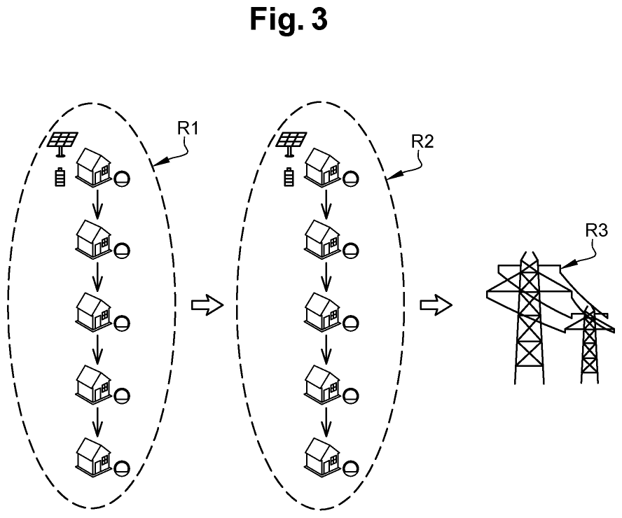

According to certain embodiments, several networks of self-consumption entities, also called pools, can be combined to further improve the collective self-consumption, i.e. to even better optimise the production of electricity. An example of two networks of self-consumption entities R1 and R2 is shown in FIG. 3, wherein the networks R1 and R2 are connected together, and are also connected to the general electricity distribution network R3.

In these embodiments where several pools are connected together, the method 100 for determining forecasts is carried out for each one of the pools, one after the other. When two pools (or networks of self-consumption entities) are combined, i.e. connected to one another via the general distribution network, the steps 120 to 160 of method 100 are implemented first for the first network of self-consumption entities, referenced as pool 1, then, if the latter has a production surplus, by the second network of self-consumption entities, referenced as pool 2. The steps 120 to 160 are then implemented by this second network of self-consumption entities in the same way that they were implemented by the first network of self-consumption entities, as explained hereinabove during the description of FIG. 5. The residual productions and consumptions of one pool then being transmitted to the following pool. When the second network pool 2 has finished implemented the steps 120 to 160, the method is reiterated, starting with step 120, by the first network pool 1 if the convergence criterion was not reached at the end of the implementation by the second network pool 2. FIG. 4 shows an example wherein the consumption and production forecasts of the first network pool 1 are transmitted to the second network pool 2 which will, in turn, add its own forecasts to those of the first network pool 1. The operations diagrammed in this FIG. 4 are reiterated until the convergence criterion is reached, for example until the self-consumption rate reaches 100%.

In the same way as for the method 100 for determining forecasts, the method 200 for establishing an energy assessment can be implemented first by the first network pool 1 then by the second network pool 2, when two pools are combined. The steps 220 to 260 implemented for the establishing of the energy assessment in the case of several pools are identical to those described hereinabove for FIG. 6; therefore they will not be described again.

When several pools are connected, and in particular more than two pools, the order for consulting the pools is determined at the beginning of a period and is modified at the beginning of each period. The choice of the order for consulting can be any of the orders for consulting described in liaison with FIG. 5.

In the particular case where an entity belongs to two pools, then this entity is consulted before the second pool. In other words, this common entity is the first entity that is consulted in the second pool. This common entity is not taken into account in the order for consulting, for example random; it is systematically the first entity consulted of the second pool.

In certain embodiments, the predefined period is divided into a plurality of time intervals, for example 15 or 30 minutes, for which an average of the values of forecasts or of actual values is associated with each time interval. This dividing of the period into time intervals makes it possible to facilitate optimising consumption and to establish a discrete-time energy assessment, allowing for easier accounting and invoicing of the electrical energy consumed by each one of the entities.

Thus, as explained hereinabove, the method for managing a flow of electricity of the invention allows for an equitable distribution by a simplified method of calculation, within one or more networks of self-consumption entities, of the energy produced by said network as well as an improvement in the self-consumption rate. An example of a comparison of the consumption results obtained, for the same network of self-consumption entities, in the case of conventional management with a single iteration according to the prior art (called PA) and in the case of management according to the method of the invention with several iterations is shown in the form of a table in FIG. 8. This example shows the gain in self-consumption (of about 23%), the increase in the quantity of self-consumed electricity (by about 75 kWh), the decrease in the surplus of electricity (by about 75 kWh) and the decrease in the quantity of electrical energy purchased from the general electricity distribution network (about 88 kWh). In addition to the gain in kWh that the method of the invention makes possible, it further allows, in certain embodiments, for simpler and more accurate accounting and invoicing of the electricity consumed, that takes into account the actual contribution of each one of the entities.

Although described through a certain number of examples, alternatives and embodiments, the method for the management of the flow of electricity and the network of self-consumption entities according to the invention comprise various alternatives, modifications and improvements that will appear obvious to those skilled in the art, with the understanding that these alternatives, modifications and improvements are part of the scope of the invention.

1. A method for the automatic management of a flow of electrical energy produced by at least one first group of prosumers and consumed by said first group of prosumers and at least one second group of consumers, wherein each entity of each group determines, at a beginning of a predetermined period, a production forecast and/or a consumption forecast of electrical energy for the predetermined period, the method comprising:
a) determining, for each group, an order for consulting the entities of the group,
b) consulting the prosumers according to the order determined in step a), each prosumer calculating a residual production forecast taking account of its own production forecasts, a residual production forecast transmitted by a preceding entity and a portion of a consumption forecast that can be supplied by the residual production forecast, and transmitting said residual production forecast to the prosumer according to the determined order,
c) reiterating step b) as long as all the prosumers have not been consulted,
d) when the residual production forecasts are in surplus, transmitting said residual production forecasts to the group of consumers,
e) consulting the consumers according to the order determined in step a), each consumer calculating and transmitting, to the consumer according to the determined order, the residual production forecast taking account of the residual production forecast transmitted by the preceding entity and of its portion of consumption forecast that can be supplied,
f) reiterating step e) as long as all the consumers have not been consulted,
g) reiterating steps b) to f) as long as a predetermined convergence criterion has not been reached.

2. The method according to claim 1, wherein step b) comprises:
calculating an aggregate production forecast that corresponds to its production forecasts added to any residual production forecast transmitted by a preceding entity,
identifying a portion of its consumption forecast that can be supplied by the aggregate production forecast,
calculating a residual production forecast that corresponds to the aggregate production forecast less the portion of its consumption forecast that can be supplied,
calculating a residual consumption forecast that corresponds to its consumption forecast less the portion of its consumption forecast that can be supplied, added to any residual consumption forecast transmitted by a preceding entity, and
transmitting to the prosumer according to the determined order, the calculated residual production forecasts and consumption forecasts;
and wherein step e) comprises:
identifying a portion of its consumption forecast that can be supplied by the residual production forecast transmitted by the preceding entity,
calculating the residual production forecast that corresponds to the residual production forecast transmitted by the preceding entity less the portion of its consumption forecast that can be supplied,
calculating the residual consumption forecast that corresponds to its consumption forecast less the portion of its consumption forecast that can be supplied, added to any residual consumption forecast transmitted by a preceding entity, and
transmitting to the consumer according to the determined order, the calculated residual production forecasts and consumption forecasts.

3. The method according to claim 1, wherein the first and the second groups of entities are connected to a general electricity distribution network, the method further comprising, at the end of at least one predetermined period, establishing an energy assessment based on a comparison, for each entity if each group, between the production forecasts and the actual production and/or between the consumption forecasts and the actual consumption of the entity.

4. The method according to claim 3, wherein the establishing of the energy assessment comprises:
1) consulting each prosumer according to the order for consulting determined in step a), each prosumer
calculating the aggregate actual production that corresponds to its actual production added to any actual residual production transmitted by the preceding entity,
identifying a portion of its actual consumption that can be supplied by the aggregate actual production,
calculating the actual residual production that corresponds to the aggregate actual production less the portion of its actual consumption that can be supplied,
calculating the residual actual consumption that corresponds to its actual consumption less the portion of its actual consumption that can be supplied, added to any residual actual consumption transmitted by the preceding entity,
transmitting said actual residual production and said actual residual consumption to the next prosumer according to the order for consulting,
m) reiterating step b) as long as all the prosumers have not been consulted,
n) consulting the consumers according to the order for consulting determined in step a), each consumer determining the actual residual consumption of said consumer and the actual residual production, and transmitting said actual residual consumption and the actual residual production to the next consumer according to the order for consulting,
o) reiterating step n) as long as all the consumers have not been consulted, and
p) establishing the energy assessment that indicates, for each one of the prosumers and consumers, the quantity of electrical energy consumed supplied by the prosumers and the quantity of electrical energy consumed supplied by the electricity distribution network.

5. The method according to claim 1, wherein the order for consulting the entities determined in step a) is modified at the beginning of each predetermined period.

6. The method according to claim 5, wherein the order for consulting is chosen randomly.

7. The method according to claim 1, wherein the consumption forecasts are optimised by each one of the prosumers and consumers according to the production forecasts and/or residual production forecasts transmitted by the preceding entity.

8. The method according to claim 1, wherein the consumption forecasts are optimised by each one of the prosumers and consumers by choosing, over time, the most appropriate moment of consumption according to the production forecasts and/or residual production forecasts transmitted by the preceding entity.

9. The method according to claim 1, wherein, when the residual production forecasts are higher than the residual consumption forecasts of the groups of prosumers and consumers, the electrical energy actually produced is stored in a storage device in order to be consumed thereafter.

10. The method according to claim 3, wherein several pools, each comprising at least one first group of prosumers and at least one second group of consumers, are connected to share the flow of electrical energy produced by the first groups of prosumers by applying, pool by pool, steps a) to g) and l) to p) when the residual production forecasts of one of the pools are higher than the consumption forecasts of said pool.

11. The method according to claim 10, further comprising establishing a global assessment that indicates, for each one of the pools, the quantity of electrical energy consumed supplied by the pools and the quantity of electrical energy consumed supplied by the electricity distribution network.

12. The method according to claim 10, wherein the pools are consulted according to an order for consulting modified at the beginning of each predefined period.

13. The method according to claim 10, wherein, when a first pool and a second pool comprise the same prosumer or consumer, said entity is consulted before the second pool.

14. A unit for processing a flow of electrical energy produced by at least one first group of prosumers and consumed by said first group of prosumers and at least one second group of consumers, the unit adapted to provide at least the determining of the order for consulting the entities, the management of the consultation of said entities and the verification of the predetermined convergence criterion.

15. A network of electricity self-consumption entities, comprising:
a plurality of prosumers and consumers connected locally to one another, and
at least one unit for processing a flow of electrical energy according to claim 14, connected to each one of the consumers and prosumers.

16. The network of electricity self-consumption entities according to claim 15, wherein the network is connected to the general electricity distribution network.

17. A non-transitory computer readable medium comprising instructions that, when the instructions are executed by a unit for processing a flow of electrical energy, implement the method according to claim 1 to automatically manage the flow of electrical energy produced by at least one first group of prosumers and consumed by said first group of prosumers and at least one second group of consumers.
